(19) United States
(12) Patent Application Publication
(10) Pub. No.: US 2015/0046372 A1
(43) Pub. Date: Feb. 12, 2015

(54) Method and System for Permanent and Continuous Preservation and Retrieval of a Data Object in the Internet Cloud

(71) Applicant: Forever, Inc., Pittsburgh, PA (US)

(72) Inventors: Glen Theodore Meakem, Sewickley, PA (US); Shane Michael Tulloch, Alexandria, VA (US); William Herbert Sands, IV, Sewickley, PA (US); Linda Marie Buckley, Sewickley, PA (US); Andrew Douglas Cox, Pittsburgh, PA (US); Stephen Eric Farrar, Pittsburgh, PA (US); Robert William Berger, Pittsburgh, PA (US)

(21) Appl. No.: 14/445,120

(22) Filed: Jul. 29, 2014

Related U.S. Application Data
(60) Provisional application No. 61/864,026, filed on Aug. 9, 2013.

(51) Int. Cl. G06Q 40/06

(52) U.S. Cl. CPC G06Q 40/06
USPC 705/36 R

(57) ABSTRACT

A method and system funding long-term data storage, retrieval, and preservation services accessed over the internet, the data services funded by an automated system seeking a target rate of return, input to the system, using pooled, one-time client payments of a client fee (20a), where the rate of return is analyzed and referenced against pre-set criteria (50b 50c) in a fund data store (50), with generated returns calculated and then apportioned (20f) so that distributed returns pay expenses incurred providing the data services, and non-distributed returns are reinvested to pay future expenses, all steps performed by a fund manager (50a) implemented as software executing on one or more computing devices or servers. A software-implemented database manager (30a) manages the data services, controlling data access by establishing an account record per client and then applying identifying information and criteria stored in various data stores (14a 30b 30c 30d).

### CROSS REFERENCE TO RELATED APPLICATION

Reference is made to and priority claimed from U.S. provisional application Ser. No. 61/864,026 filed on Aug. 9, 2013.

### TECHNICAL FIELD

The present invention pertains to the field of preserving data, typically digital data, in the internet cloud. More particularly, the present invention pertains to a method and system for continuously preserving data over a long period of time, defined as at least ten years, where stored data can be instantly and easily retrieved in the internet cloud using a variety of communication devices.

### BACKGROUND OF THE INVENTION

Advances in communication technology have transformed data from the physical to the ephemeral. Today's photograph is far more likely expressed as a jpeg file stored on a mobile smartphone, rather than as a piece of paper lovingly curated in a scrapbook. The rise of the internet coupled with wireless technologies has allowed us to conduct virtually all of our lives in the internet cloud, but the ease with which we are able to communicate seamlessly with one another, anyplace and anytime, has spawned the evil twins of the digital information age: data overload and data destruction. Data today often exist in multiple places and in multiple formats, and coupled with email and other forms of digital data, the process of tracking, organizing, consolidating and preserving data is an overwhelming and daunting task.

A common solution to the data overload problem is to upload data onto third-party social media sites such as Facebook®, a social media networking service owned by Facebook, Inc., and Flickr™, a site owned by Yahoo! Inc., providing online photo album archiving services. Data owners believe these sites preserve their data, but the exact opposite is often true instead. Since data storage is expensive, and the rate at which data is communicated is directly correlated to the amount of data being transmitted, social media sites regularly perform file compression, overtly or quietly, so as to facilitate data sharing. Such compression often permanently destroys data because the saved space is reused, and unless the data owner has another uncompressed copy of the data somewhere else, the discarded data is irretrievably lost. Data loss through compression is a common problem with visual data, but extends to all digital files. Music, for instance, stored in MP3 format lacks the subtly and depth of music stored on CDs. Some third-party social media sites allow data owners to choose levels of compression for their data, and many force data owners to compress and thus discard portions of their data before uploading.

Worse, many “free” services fund their services by selling access to data. For instance, the Apr. 10, 2013 issue of The Wall Street Journal chronicled how advertisers purchase access to Facebook, Inc. accounts in the article “Buy Signal: Facebook Widens Data Targeting.” In essence, data owners have been unwittingly trading data privacy for “free” data sharing and storage services. For Facebook, Inc., selling access to information is the only way the company can pay for its services without charging data owners. Many data owners feel uncomfortable with the selling of their information, but the ongoing cost of private data storage is high and mostly limited to back-up services, rather than true social media such as Facebook, Inc., where data owners can easily share their photos, etc. with others.

Another common reason why data owners continue to store their data at social media sites is that despite their unease with data mining, they believe their data is permanently stored in a convenient cloud solution. Sadly, many of these owners lose control over the very data they are consciously trying to preserve. Since legislation covering digital data is patchy and/or non-existent, every third-party data service company contracts privately with data owners. These contracts often preclude or severely limit data access and transfer during the lifetime of the data owner, as well as after death due to concerns over strong privacy laws. The majority of these companies, since they have no contractual relationship with an executor, family member, or friend of the deceased data owner, cannot give access to data stored in the data owner's account and cannot transfer the account without an instruction from the deceased data account owner.

On the privacy front, companies are sympathetic to a surviving spouse's desire to access the decedent's data account, but privacy concerns prevail: the data owner may have never intended to share certain data with others. The inventors are unaware of any system currently available providing customized privacy level settings for each individual data object stored in an account. Thus, in some cases the data owner's account is permanently locked and access is denied to all, and in other cases, all the data is accessible, but immutable. In all cases, the data, whether accessible or not, will eventually be destroyed by the third-party site owner, if storage service fees are unpaid, or in the case of free accounts, is unused for a period of time, to allow the data storage allocated to those unused accounts to be used for active accounts that have the possibility of generating income for the company. Permanent, continuous data storage thus does not currently exist because without an ongoing funding mechanism, it is too expensive to be maintained.

Numerous articles have appeared in the past few years on the real problems of taming data overload, attaining continuous data preservation, and enabling others to access data: The Wall Street Journal's “What a Tangled Web We Leave,” Feb. 1, 2013, discusses some of the frustrations of a surviving spouse after the untimely death of her husband as she tried to deal with his digital assets and accounts. In The New York Times newspaper, the article “Hey, at Least You Can be Virtually Immortal,” Mar. 12, 2013 discusses the ability of technology to allow people to be remembered, and how some people are trying to archive and preserve their data. Another article, in The New York Times Magazine, “Cyberspace When You're Dead,” Jan. 5, 2011 documents the agony of friends and family who tried desperately but failed to save the online data of an individual who died unexpectedly. Their story is far too common: the deceased's Flickr™ photo account lapsed because no one else could renew it. The individual's blog remained online, but its long term viability was uncertain as it was a free account storing data, and without a password, no one else could maintain the account to keep it viable. This list of articles is a sampling of many published on this subject, but none have a good solution.

Recently, some companies have attempted a single fee for long term services that are not classic subscription services, the terms typically being less than 10 years, and when they failed, the clients were given short notice to retrieve their data from the service databases before the service ended and destroyed their stored data.

What happens to one's digital works, life, and legacy after death? Currently, data preservation in the internet cloud is murky and fraught with uncertainties. Even estate lawyers struggle to craft effective estate plans for transferring digital properties to heirs.

What is needed is a simple method and system for permanently and continuously preserving, accessing, and controlling data that does not require regular maintenance fees to fund such services, maintains data private from advertisers, and allows data owners to authorize access to data associated with the account, with privacy levels for each data object stored.

What is also needed is a method and system that is easily accessed using a communication device, such as a smartphone, on demand from any location globally, to access the data system and stored data.

### DISCLOSURE OF THE INVENTION

Accordingly, in a first aspect of the invention, a computer-implemented method is provided for storing and retrieving a data object of a client, the method comprising: establishing an account record for the client and related account settings and criteria; selecting a client data store upon receiving the data object to store and also information relating the data object to the account record, by applying the account settings and criteria; and storing the data object in the client data store according to the account settings and criteria; wherein in establishing the account record, a one-time fee is imposed on the client commensurate with an agreed-on maximum volume of data to be stored for the client, and then is collected and invested in a fund holding fees collected also from other clients, and the fund is then invested according to a goal for a rate of return set so as to ensure that the return from investments is sufficient to cover all costs of storing data for the clients for at least ten years.

In accord with the first aspect of the invention, the invention further provides a step of selecting a level of compression for the data object prior to storing the data object, where the compression level of the data object prior to storing may be a same compression level (file size) as the selected compression level for the stored data object, or may be a different compression level for the stored data object, so as to allow the client choices in allocating data storage purchased for the one-time fee.

Also, in accord with the first aspect of the invention, the invention further provides a step of receiving a request to retrieve the data object, the request including an indication of the relevant account record and information intended to confirm the validity of the request, and then validating the request by comparing the information included with the request with information in the account settings and criteria and the account record. Further, the account settings and criteria provide a plurality of pre-defined possible levels of privacy from which a privacy level is selected for each data object, such that when the request to retrieve is validated, access is allowed or denied based in part on the level of privacy selected for the data object for which access is requested.

Also, in accord with the first aspect of the invention, the invention further provides a step of converting the stored data object into a file format appropriate for retrieval by a communication device requesting retrieval of the data object and with appropriate resolution, wherein providing for the appropriate resolution, a selection is made of at least one of a first resolution appropriate for viewing the data object on a display screen and a second resolution appropriate for copying the data object in accordance with the retrieval request. The request to access the data object includes information as to the type of access desired, and for quick access for viewing the data object on a smartphone or other communication device the first resolution is appropriate for viewing but inappropriate for copying the data object, where a second resolution having a larger data file is appropriate but requires more time to access.

Also, in accord with the first aspect of the invention, the invention further provides steps of analyzing the returns from investments, apportioning the returns from investments based on the analysis so as to distribute a portion of the returns and reinvest all non-distributed returns. In analyzing the returns, a rate of return goal is at least four percent returns annually calculated after inflation and taxes over the ownership peri

A second aspect of the invention provides a computer-implemented system for storing and retrieving data for a client, comprising modules executable by a computer processor so as to perform the steps of a method according to the first aspect of the invention.

A third aspect of the invention provides a computer-implemented system for storing and retrieving data for a client, comprising a database manager module provided so that upon receiving from the client a data object to store and information relating the data object to account record, the database manager module selects a data store by applying account settings and criteria related to the account record, and stores the data object in the data store.

In accord with the third aspect of the invention, the invention provides a fund manager module for imposing and collecting from the client a one-time fee commensurate with an agreed maximum volume of data storage, and for investing the fee in a fund holding fees collected also from other clients, the fund includes investments selected from a set of investment options according to a goal for a rate of return set so as to ensure a return from the investments sufficient to cover all costs of storing data for the clients for a term of at least ten years for each client as set forth in an agreement with each client and commencing with the agreement. Further, the database manager module is provided so as to evaluate a request to retrieve the data object stored in the data store, the request made by a communication device, by comparing information accompanying the request included to confirm the validity of the request with the account settings and criteria. Still further, the database manager module is provided so as to convert a file format of the data object into a file format in accordance with the request, wherein the file format is at least a first resolution level appropriate for viewing by a display screen of the communication device, and a second resolution level appropriate for copying the data object. Still further, the database manager module is provided so as to set a level of privacy for the data objected selected from a plurality of predetermined possible levels of privacy.

### BRIEF DESCRIPTION OF THE DRAWINGS

The features and advantages of the invention will become apparent from a consideration of the subsequent detailed description presented in connection with accompanying drawings, in which:

FIG. 1 is a diagrammatic representation illustrating a system for long-term storage and retrieval of a data object in the internet cloud according to the invention.

FIG. 2 is a diagrammatic representation illustrating a method by which clients store and retrieve data objects using the system in FIG. 1.

FIG. 3 is a diagrammatic representation illustrating a funding method for the system in FIG. 1.

### DETAILED DESCRIPTION

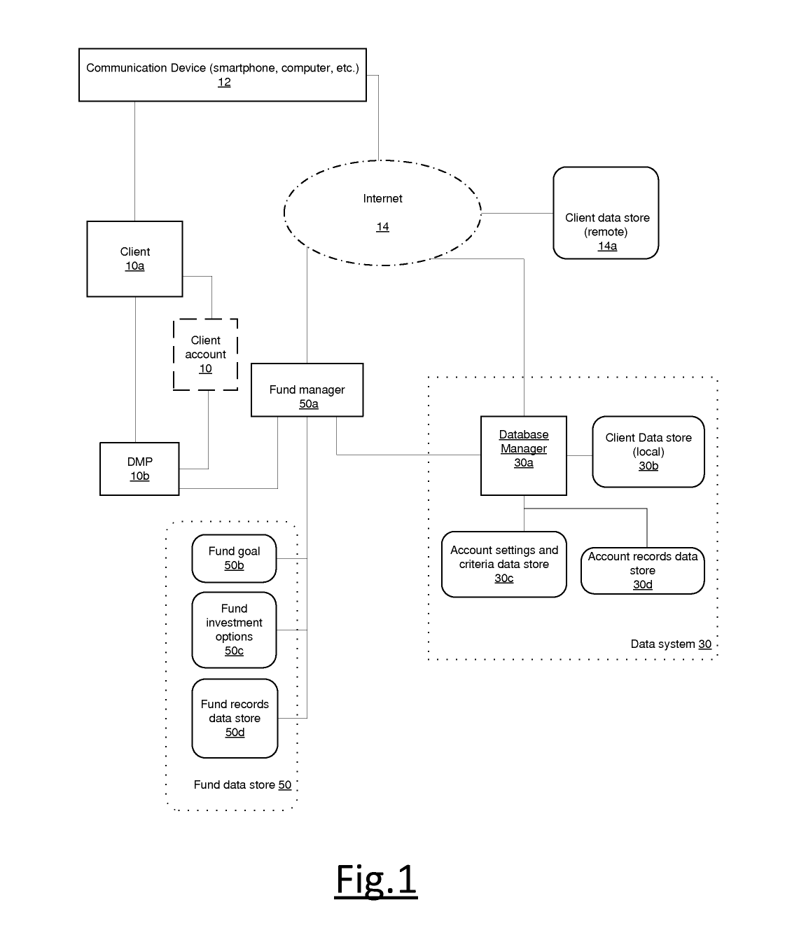

A method and a system providing permanent, continuous data preservation and retrieval of a data object in an internet cloud according to the invention are illustrated in FIGS. 1-3.

Referring to FIG. 1, the invention provides a system for storing and retrieving a data object from one or more clients 10a, including a fund manager 50a that is a goal-driven automated investment manager, and a database manager 30a that stores data from a client 10a in a local client data store 30b or a remote client data store 14a, according to account settings and criteria established by the client 10a via the database manager 30a, the costs of operation of the database manager 30a, including all costs for storage and later retrieval of client data, being paid using a portion of returns on the investments made by the fund manager 50a using monies accumulated through imposing a one-time fee on the client 10a for a maximum volume of data storage and retrieval space, and to each other client also engaging the data storage and retrieval service provided by the invention.

The database manager 30a and the fund manager 50a are both implemented as software provided to execute on one or more computing devices or servers, and so stored as executable code on memory devices accessible to such computing devices or servers after an operating system for each is loaded in a bootup procedure. The operating system or systems then load the fund manager 50a and the database manager 30a into memory and initiate their execution.

In actual operation, the client 10a first transacts with a data management provider or DMP 10b offering a service according to the invention, forming a client account 10, by which the DMP 10b promises to maintain the data system 30 providing data storage and retrieval services for a prolonged term, or in some embodiments, for at least ten years, and it is an object of the invention to provide data storage and retrieval services forever, and another object of the invention to preserve the full resolution of the data object for the entire storage period.

After payment of the one-time fee, or at least after payment of a first one of an agreed number of payments that in total would yield the one-time fee and agreed-on interest, the fund manager 50a interfaces with the database manager 30a to establish a record of the client account 10, which is then stored by the database manager 30a in an account record data store 30d. The information here includes information such as names, addresses, and other identifying information, as well as the volume of storage and retrieval space purchased.

Next, the client 10a interfaces with the database manager 30a to establish the account settings and criteria which the database manager 30a stores as one or more records in a corresponding account settings and criteria database store 30c in such a way that they are related to the record for the client account in the account records data store 30d.

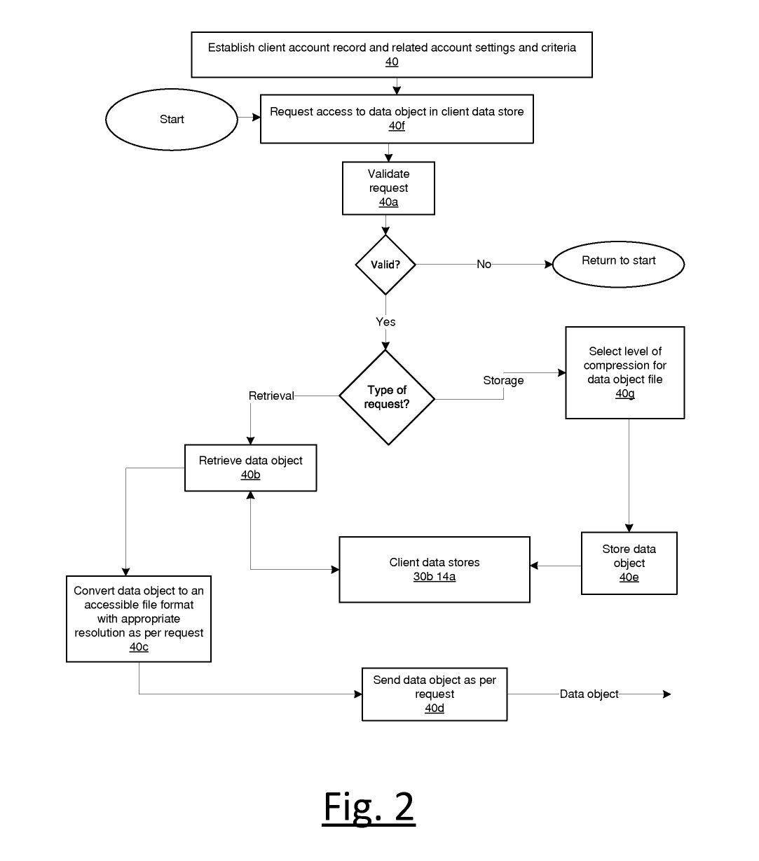

Finally, the client 10a interfaces with the database manager 30a to provide a data object for storage. Looking at FIGS. 1 and 2, a request for access 40f to a client data store 14a 30b associated with a specific client account is made by the client 10a using a communication device 12 over an internet cloud 14. The term “communication device” here includes any device, such as a computer, a smartphone, a tablet, or another electronic device, owned by anyone, capable of connecting to the data system 30 web interface.

The request is then validated 40a by the database manager 30a applying the account settings and criteria and the account record stored in their respective relevant data stores 30c 30d. If the request is not valid, the request is denied and no access is provided to client data stores 14a 30b.

If the request is valid, the database manager 30a processes the request for storage of the data object. Upon receipt of the data object, accompanied by information indicating the identity of the client 10a coinciding with information stored in the accounts records data store 30d, the database manager 30a refers to the account record data store 30d to look up, among other things, the total amount of space the client has purchased, and to determine an index for referring to the account settings and criteria data store 30c, which the database manager 30a accesses next, in order to determine where to store the data object, and, in some implementations, what level of encryption to use, what if any special password or other security measure is required for subsequent access. The data object is then stored 40e. In some embodiments, a compression level 40g of the stored data object is different from a compression level of the unstored data object, typically the stored data object having a higher compression level, as decided by the client 10a, to allow the client 10a control in deciding how to use the volume of data storage and retrieval space purchased by deciding which data can be compressed (and thus decrease storage space required) and which data must be preserved in its original uncompressed state. In some embodiments, a file format for the stored data object may be a different file format as compared to the original, pre-storage file format, either by request of the client 10a or by the database manager 30a automatically changing the file format as it deems necessary. Many file formats commonly used now, such as jpeg and pdf, may fall out of common use at a future date due to technological advances, and thus a relatively “old” file format may occupy a larger volume of data storage and retrieval space as compared to a relatively “newer” file format, and thus the client 10a or the database manager 30a may elect to change the file format, without necessarily eliminating data, to reduce costs associated with storage and retrieval.

The local client data store 30b is typically provided as a single database storage unit or several database storage units managed by the DMP 10b that are not accessed through the internet cloud 14 and which store the client's data. A “data object” is a logically related information in digital form, which in the present context includes information that relates the data object to a particular client, such as a digital photograph associated with a client name. “Data store” means a data repository of a set of logically related data objects, and includes databases. “Database” means an apparatus or assembly, in the singular or plural, that stores data owned by the client in an onsite, offsite, or remote database accessible via the internet 14, regardless of ownership or control of that apparatus or assembly. The remote client data store 14a includes third-party social media sites, other sites such as online banks, and still other sites that host data storage for the client. The DMP 10b may also own and operate remote client data stores 14a, and the inventors contemplate multiple remote client data stores 14a to ensure clients 10a constant accessibility to their stored data and from any location globally, regardless of localized power outages, inclement weather, and physical destruction of any given client data store 30b 14a. Decentralizing storage and having one or more computers also allow for system updates and repairs, minimizing disruption or downtime of the data system 30.

When retrieving 40b the data object, the client 10a can choose to retrieve the data object in its original, uncompressed storage form, and in its original file format, or choose to convert 40c and compress the data object and/or change the format as desired. For instance, a relatively large jpeg file might be changed to a pdf format and compressed because the communication device used to retrieve the data object may not be able to open certain file formats or file sizes. Quick access, such as viewing the data on a computer or a smartphone screen, is typically provided in a compressed format to allow rapid upload and access. Deep access, such as when the client 10a requires access to an entire uncompressed data object for printing an 8″×10″ photograph, is also provided as requested by the communication device 12 and according to the account criteria and settings.

Since each data object is individually associated with its account record and its account settings and criteria, and each request to access the client data stores 14a 30b and the relevant data object is similarly associated with identifying information pertaining to the individual making the request, the database manager 30a can analyze and validate 40a such requests by comparing the requesting individual's identifying information with information pertaining to a preset privacy level 40 for the data object in question, and thus control how a specific data object may be accessed, the type of access allowed, and by whom. Establishing 40 the account record and account settings and criteria include selecting a level of privacy from a plurality of pre-defined possible privacy level settings for every data object stored in the client data stores 14a 30b. The plurality of pre-defined possible levels of privacy settings include a personal level, which limits access to the specific data object with this setting to just access by the client 10a, who has unlimited access to the data object, a public level, which allows anyone to access the data object without limit, and various privacy levels in between. “Access” here includes viewing, copying, deleting, sharing, and otherwise manipulating the data object, and for instance, a public level setting for a specific data object would allow anyone to view, copy, share and even remove the data object from the client data stores 14a 30b. A more limited privacy level, such as one selected for data pertaining to the client's friends, would allow limited access to a specific data object, for example, viewing and sharing, but not access that permits destroying or otherwise altering the data object. In the event the client 10a does not actively set privacy levels, the database manager 30a will automatically apply default account settings and criteria as detailed and agreed upon in the client account 10. The client 10a may elect to retain the default settings, or at any time change the account settings and criteria, as desired.

It should be noted that while the inventors commonly refer to stored data objects as “data objects stored in the client account 10,” this phrase means data stored in the local client data store 30b or remote client data store 14a, as determined by the database manager 30a, that are associated with specific client account information.

When setting the account settings and criteria, choosing privacy level settings allows the client 10a to create a plurality of different social circles and share different information with these social circles by categorizing individuals into group lists, typically sorting individuals into professional, family/friends, or other groups. In turn, each group list can have multiple private groups for sharing different content. For example, the family/friend group lists may provide for a first group including the client's mother, and a second group excluding the client's mother but including close personal friends so that a data object the client may not want to share with a parent can still be shared with select friends. Privacy level settings also control access to the data

It is an object of the invention to allow the client 10a full use of remote data stores 14a, such as social media sites, and allow access to the data stored in the data store 30b and remote data stores 14a according to privacy level settings. In some embodiments, the remote data stores 14a transfer their data to the local client data store 30b, and in other embodiments, remote data stores permit data flow from the local client data store 30b to their remote data stores. In this way, data stored in various social media sites, such as Facebook®, and other sites, such as online banking, can easily be transferred to the client data stores 14a 30b associated with the client account 10, consolidating all information into a single convenient location, and/or allow these other remote data stores 14a to selectively access data stored in the local client data store 30b, following the account settings and criteria and to the account record. The invention thus is a centralized hub linking all of the client's online data.

Further, the invention provides each client account 10 a permanent, unique domain name included as part of the data storage and retrieval service. This unique domain name is owned by the client 10a, and being intellectual property, can be maintained, transferred, sold, or abandoned by the client as desired.

Even further, upon establishing 40 the account record and account settings and criteria, the client 10a may also designate one or more individuals to serve as account managers with varying authorizations to control data stored in the client data stores 14a 30b. The invention provides for the appointment of a series of account managers, however, the first named account manager retains the rights granted by the client 10a until the account manager's death or relinquishment of control, upon which the second named account manager and so forth take control of the account in accordance with the designation of control given by the client 10a. In the event of a dispute, the DMP 10b is designated by the client account 10 as the master administrator of the account via the default settings.

The invention provides the client 10a complete control over every data object associated with the client account 10. The DMP 10b has no ownership in any data object stored in any client data store 14a 30b, no ability to copy or transmute the data except in the provision of the data storage and retrieval services, and no other rights to any data. For instance, the DMP 10b is able to alter the file format of the stored data object so as to ensure accessibility by communication devices 12, but cannot sell or offer access to any data object without the prior authorization of the client 10a.

Upon notification of the client's death, the DMP 10b, following the default settings, will preserve the data as it existed as of the date of the client's death, and will not allow any manipulation of the data. Settings, such as privacy levels and group lists, under the default settings will be preserved as of the date of the client's death. If the data was placed in a personal layer, defined as a privacy level that only permits client 10a or a full account manager (a manager with a same control as a client in regards to the data) access, the DMP 10b will preserve the data but prevent access to it by others. The inventors note that these default provisions only come into play when the client 10a has not addressed how the data will be controlled after the client's death, and by appointing account managers, settings such as levels of privacy can override the default settings.

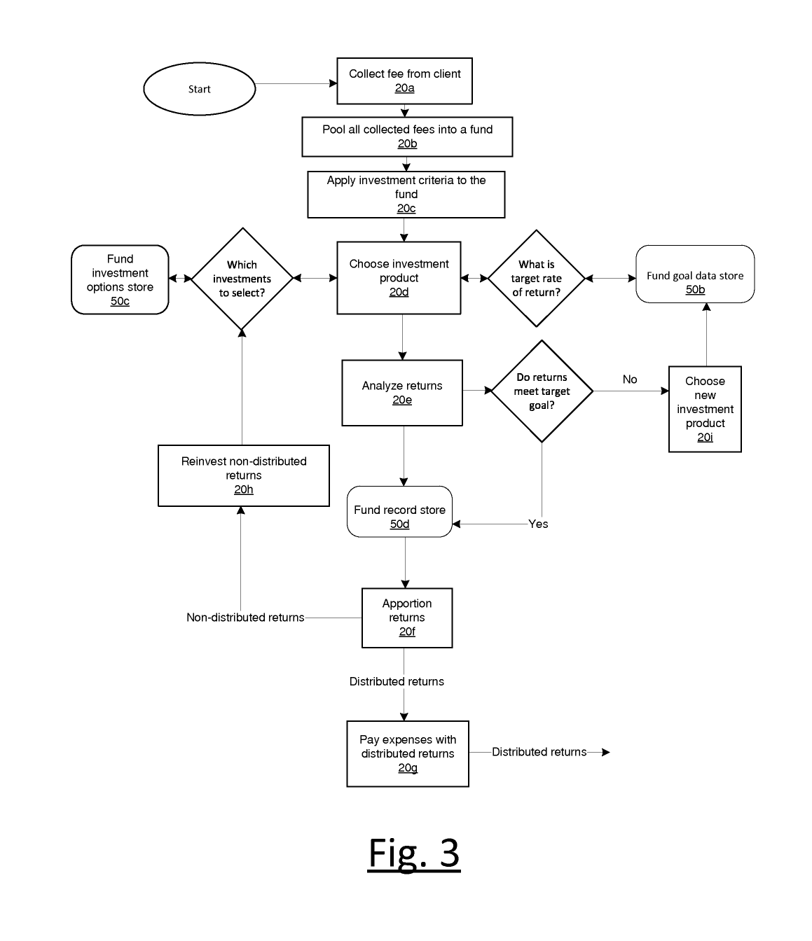

Costs associated with providing the data storage and retrieval services are paid for by a funding system and a funding method, shown in FIGS. 1 and 3. To ensure that the DMP 10b honors the terms of the client account 10, the DMP 10b selects various different fund investment options 50c and stores them in a fund data store 50, via an interface with the fund manager 50a. These options may be changed, from time to time, by the DMP 10b, at its discretion, although the DMP 10b follows a plurality of fund goals 50b and fund investment options 50c stored in the fund data store 50. The DMP 10b establishes a target rate of return 50b for investments made by the fund manager 50a; the target rate of return serves as a goal driving the investment manager to incur more or less risk in endeavoring to earn a sufficient return to cover all costs of operating the service. When the client 10a and the DMP 10b establish the client account 10, the client 10a then interfaces with the fund manager 50a for payment of the one-time fee 20a, and establishes a fund records data store 50d, where the fund manager 50a stores records created of all of the fees paid, the current account balance, and includes records of returns earned by investing such fees, a portion of returns distributed in order to pay expenses 20g associated with the service (such as office overhead and taxes), and a remaining portion of non-distributed returns that are reinvested.

The DMP 10b can, via another interface with the fund manager 50a, ascertain the balance of the fund, and, at his discretion, alter the target rate of return 50b and/or the investment options 50c and select new investment products 20i. To do so, the DMP 10b would take into account the operating costs of the service via sources of information not shown. Changing the rate of return or investment options, for instance, is typically made by altering criteria stored in the fund data store 50. For instance, the period over which the rate of return is calculated can be set to five years, or longer or shorter terms, as desired.

The funding system thus is a goal-driven system of financing the data storage and retrieval services by applying investment criteria designated by the client account 10 and stored in the fund data store 50, along with information stored in the account record data store 30d. The fund is created by an operator (not shown) who selects the investment products for the fund and coordinates initial capitalization of the fund using investor funds or other monies, or in another embodiment, the operator is in fact the fund manager 50a, applying the fund data store 50 criteria to choose investments for the fund. Once established, the funding system is computer-implemented and fully automated, with the fund manager 50a applying the information in the fund data store 50 to: (1) generate sufficient returns to keep the system self-funding, (2) analyze returns 20e, such as the total amount of returns, (3) apportion 20f returns into distributed and non-distributed returns, (4) determine the percentage of returns to distribute and when such distributions take place, (5) determine when and how to pay expenses 20g associated with providing the data storage and retrieval services, (6) analyze the sufficiency of the distribution as compared to expenses 20e, (7) analyze whether the returns generated meet the target rate of return; (8) reinvestment of non-distributed returns 20h, and (9) analyze the sufficiency of the distributed returns compared to expenses.

The funding method fulfills the promise that payment of the one-time fee purchases a defined volume of data storage retrieval space for an indefinite term. After collecting fees owed 20a, the fees are then pooled 20b together by the fund manager 50a, who by applying 20c investment criteria to the fund, selects and invests 20d in the selected investment products to create the fund. The fund is owned and operated by the DMP 10b, and exists solely to finance the data storage and retrieval services, and thus is properly called a restricted fund. In other embodiments (not shown), the one-time fee is structured as a series of regular payments instead of a single fee or payment, and may resemble a subscription, but the series of payments are not the same as a subscription-funded service, where failure to continue to pay results in stopped services, but rather a financing option. “One-time fee” here means a fixed price for a fixed, maximum volume of data storage and retrieval space, and does not refer to the number of times payment is made (once) nor preclude financing arrangements such as a series of small payments equaling the fee owed. In some embodiments, a small interest payment may be added when a financing arrangement is made. However, once the client 10a pays the entire fee amount owed (perhaps with interest), no more payments are required for continued use of the data system 30.

The fund may be an index fund, resemble a money-market fund, or contain other investment products. The funding system and method as provided by the invention may invest in a wide range of investment products to expose the fund to a desired asset class. The inventors note that the fund is NOT an endowment fund, since the DMP 10b is a for-profit organization and endowment funds are typically owned by charitable and non-profit organizations. The fund generates returns of about four percent of the annual returns after taxes and inflation, or about one percent quarterly, which are then paid out of the fund to pay for expenses related to providing the data storage and retrieval services, such as taxes, salaries, etc. All remaining non-distributed returns are reinvested automatically 20h into the fund along with any new client fees with the purchase of a new maximum volume of data storage and retrieval space. It should be noted that once the fund is established, all subsequent activities related to the fund, such as apportioning returns into distributed and non-distributed returns 20f and distributing returns to pay for expenses 20g, are automatically performed by the fund manager 50a, and thus the funding method and system are fully automated.

The inventors note that “returns” and “income” are terms of art in the financial services industry. The inventors' use of the word “returns” means any form of return generated by investing assets, including interest, dividends, capital gains (realized and unrealized), profit distributions, stock distributions, and any other form of return from an asset (stock, bond, real estate, commodity, mutual fund, exchange traded fund, private business, etc.). “Income” has a more narrow meaning in the financial services industry, namely interest or a cash distribution but excludes, for example, capital gains, and the term “income” is used here as it is commonly understood in the financial services industry.

In some embodiments, the DMP 10b is able to alter the annual percentage distribution payable to the DMP 10b to more than four percent per year or less than four percent per year by adjusting the fund criteria in the fund data store 50. Such adjustments depend on current market forces, desired rate of return, and goals to preserve the restricted fund's capital so as to create a self-sustaining mechanism to pay for the data storage and retrieval system. The inventors understand a lower annual percentage may adequately fund the service in cases such as where the fund capital is so large that it generates relatively large returns, or in cases such as improvements in technology decreasing data storage costs. The inventors however do not believe that the fund is capable of being sustained permanently, as is an object of the invention, if annual distributions from the fund exceed more than four percent per year over multiple years

The funding system and method are integral components of invention allowing the data storage and retrieval service to be decoupled from the prior art model of service subscriptions requiring regular periodic payments to fund data storage services, and in which once the subscription payment ends, the data storage service ends as well. Historically, relatively “longer” subscription periods, such as a single fee paying for a 5 year subscription for services, have resulted in failure during the fixed period. The fund, unlike an endowment, trust, or other funding method, provides a stable funding stream that cannot be “looted” or emptied by the DMP 10b or anyone else. For instance, the prior art uses a combination of trusts and non-profit organizations to provide ongoing funding, but this system subjects the fund to a variety of changing state and federal regulations, increased expenses related to compliance, and other uncertainties that have rendered these solutions incompatible with the goal of permanent and sufficient funding. The mission of an endowment, for instance, is subject to interpretation and that interpretation often changes over time. Trustees appointed to manage trusts perform their duties use discretionary powers, including the classic ability to incur “reasonable fees,” which rely heavily on the judgment of the trustee. The prior art funding system is heavily dependent on expensive human labor to both manage the funding and the provision of the data services, resulting in costs that are difficult to control or even ascertain over the long term.

In contrast, funding system and method of the invention are stable do not rely heavily on manual support systems since once established, they are fully automated. Importantly, the fund monies cannot be used for anything other than financing the services provided, and cannot be dispersed for any reason other than to fund such services. As the fund manager 50b is applying established criteria in the fund data store 50, there is little ability for “looting” of the fund monies for other uses, as is possible with the prior art models used.

Thus, the fund is a restricted, permanent fund whose sole existence is to fund the data system 30, and as such, the data services can continue to be provided even if the original company with whom the client contracted ceases to exist, for any reason. In the event the DMP shuts down, there are provisions allowing the fund manager 50a to appoint another data management provider upon consulting and applying the fund data store 50 criteria. The inventors believe their “four percent solution” as a component of their unique funding system and method solve the conundrum of the ease of a single fee being able to pay for enduring service arrangements.

It is to be understood that the above-described arrangements are only illustrative of the application of the principles of the present invention. Numerous modifications and alternative arrangements may be devised by those skilled in the art without departing from the scope of the present invention.

What is claimed is:

1. A computer-implemented method for storing and retrieving data for a client comprising the steps of:
establishing (40) an account record for the client and related account settings and criteria;
receiving (40f) from the client a data object to store and also information relating the data object to the account record and selecting a client data store (14a 30b) by applying the account settings and criteria; and
storing (40e) the data object in the client data store (14a 30b) according to the account settings and criteria;
wherein in establishing the account record, a one-time fee is imposed on the client commensurate with an agreed-on maximum volume of data to be stored for the client, and the method further comprises the step of:
investing (20d) the fee in a fund holding fees collected also from other clients, the fund including investments selected from a set of investment options (50c) according to a goal (50b) for a rate of return set so as to ensure a return from the investments sufficient to cover all costs of storing data for the clients for a term of at least ten years for each client as set forth in an agreement with each client and commencing with the agreement.

2. The method of claim 1, further comprising the steps of:
receiving (40f) a request to retrieve the data object, the request including an indication of the account record and information intended to confirm the validity of the request; and
validating (40a) the request by comparing information intended to confirm the request is valid with the account settings and criteria and the account record and if so, retrieving the data object in the client data store (14a 30b) according to the request (40f).

3. The method of claim 1, further comprising the step of selecting (40g) a level of compression for the data object before the step of storing (40e) the data object.

4. The method of claim 2, further comprising the step of:
converting (40c) the stored data object into a file format appropriate for retrieval by a communication device (12) requesting retrieval of the data object and with appropriate resolution;
wherein in providing for appropriate resolution, a selection is made of at least one of a first resolution level for the data object appropriate for viewing by a display screen and a second resolution level for the data object appropriate for copying the data object in accordance with the retrieval request.

5. The method of claim 1, further comprising the steps of:
analyzing (20e) the returns from investments; and
apportioning (20f) the returns from investments based on the analysis so as to distribute only a portion of the returns; and
reinvesting (20h) non-distributed returns.

6. The method of claim 5, wherein the step of apportioning (20f) is performed by a fund manager (50a).

7. The method of claim 1, wherein the goal (50b) is at least four percent returns annually, after inflation and taxes, over an ownership period.

8. The method of claim 1, further comprising the step of:
setting (40) a level of privacy for the data object selected from a plurality of pre-defined possible levels of privacy.

9. A computer-implemented system for storing and retrieving data for a client, comprising modules (50a 30a) executable by a computer processor so as to perform the steps of the method of claim 1.

10. A computer-implemented system for storing and retrieving data for a client, comprising:
a database manager module (30a) provided so that, upon receiving from the client a data object to store and information relating the data object to an account record, the database manager module (30a) selects a data store (14a 30b) by applying account settings and criteria related to the account record, and stores the data object in the data store (14a 30b); and
a fund manager module (50a) for imposing and collecting from the client a one-time fee commensurate with an agreed maximum volume of data storage, and for investing the fee in a fund holding fees collected also from other clients, the fund including investments selected from a set of investment options (50c) according to a goal (50b) for a rate of return set so as to ensure a return from the investments sufficient to cover all costs of storing data for the clients for a term of at least ten years for each client as set forth in an agreement with each client and commencing with the agreement.

11. The system of claim 10, wherein the database manager module (30a) is provided so as to validate a request to retrieve the data object in the data store (14a 30b), the request accompanied by an indication of the account record and information intended to confirm the validity of the request by comparing information included with the request with the account settings and criteria.

12. The system of claim 10, wherein the database manager module (30a) is provided so as to convert a file format of the data object into a file format appropriate for a communication device (12) requesting retrieval of the data object, wherein the appropriate file format is at least a first resolution level for the data object appropriate for viewing by a display screen of the communication device (12) and a second resolution level for the data object appropriate for copying the data object in accordance with the retrieval request.

13. The system of claim 10, wherein the database manager module (30a) is provided so as to set a level of privacy for the data object selected from a plurality of pre-defined levels of privacy.
